(19) United States
(12) Patent Application Publication
(10) Pub. No.: US 2015/0143045 A1
(43) Pub. Date: May 21, 2015

(54) CACHE CONTROL APPARATUS AND METHOD

(71) Applicant: ELECTRONICS AND TELECOMMUNICATIONS RESEARCH INSTITUTE, Daejeon (KR)

(72) Inventors: Jin Ho HAN, Seoul (KR); Young Su KWON, Daejeon (KR); Kyoung Seon SHIN, Daejeon (KR)

(73) Assignee: ELECTRONICS AND TELECOMMUNICATIONS RESEARCH INSTITUTE, Daejeon (KR)

(21) Appl. No.: 14/253,466

(22) Filed: Apr. 15, 2014

(30) Foreign Application Priority Data
Nov. 20, 2013 (KR) 10-2013-0141596

(51) Int. Cl. G06F 12/08

(52) U.S. Cl. CPC G06F 12/0811; G06F 2212/6022
USPC 711/122

(57) ABSTRACT

Provided are a cache control apparatus and method for reducing a miss penalty. The cache control apparatus includes a first level cache configured to store data in a memory, a second level cache connected to the first level cache, and configured to be accessed by a processor when the first level cache fails to call data according to a data request instruction, a prefetch buffer connected to the first and second level caches, and configured to temporarily store data transferred from the first and second level caches to a core, and a write buffer connected to the first level cache, and configured to receive address information and data of the first level cache.

### CROSS-REFERENCE TO RELATED APPLICATIONS

This application claims priority under 35 U.S.C. §119 to Korean Patent Application No. 10-2013-0141596, filed on Nov. 20, 2013, the disclosure of which is incorporated herein by reference in its entirety.

### TECHNICAL FIELD

The present invention relates to a cache control apparatus and method for increasing a hit rate and reducing a miss penalty.

### BACKGROUND

A processor is a device that reads an instruction stored in an external storage device, analyzes the instruction to perform an arithmetic operation using an operand designated by the instruction, and again stores the instruction in the external storage device, thereby performing a specific function according to a stored program.

The processor is applied to various fields, and performs various and complicated functions. A function of the processor is being used in various application fields such as video encoding/decoding, audio encoding/decoding, network packet routing, system control, etc.

As the processor is applied to various application fields, the processor processes various types of instructions, and is used in various types of devices (which is supplied with power) ranging from a base station for wireless communication to a device (for example, a wireless communication terminal) to which power is supplied from a battery. Therefore, in addition to a performance of the processor, a low power function is becoming an increasingly important issue.

The processor is fundamentally configured with a core, a translation lookaside buffer (TLB), and a cache.

Work performed by the processor is defined as a combination of a plurality of instructions, which are stored in a memory. The instructions are sequentially input to the processor, which performs an arithmetic operation at every clock cycle.

The TLB is an element that converts a virtual address into a physical address, for driving an application based on an operating system (OS).

The cache is an element for enhancing a performance of a system. Also, the cache is a buffer type of high-speed memory unit that stores instructions or programs read from a main memory unit. The cache temporarily stores an instruction (which is stored in an external memory) in a chip, thereby increasing a speed of the processor.

The external memory stores a large-scale instruction of several Gbytes or more (256 Gbytes or more), but a memory implemented in a chip has a capacity of several Mbytes. The cache is an element in which an external large-capacity memory is temporarily equipped in a chip.

The core expends much time of 10 to 100 cycles for reading data from the external memory, and for this reason, an idle state in which the core does not perform work is maintained for a long time.

Moreover, in using the cache, it is required to reduce penalty for a miss and increase a hit rate, for increasing whole system efficiency.

### SUMMARY

Accordingly, the present invention provides a cache control apparatus and method for increasing a hit rate of a cache and reducing a miss penalty.

In one general aspect, a cache control apparatus includes: a first level cache configured to store data in a memory; a second level cache connected to the first level cache, and configured to be accessed by a processor when the first level cache fails to call data according to a data request instruction; a prefetch buffer connected to the first and second level caches, and configured to temporarily store data transferred from the first and second level caches to a core; and a write buffer connected to the first level cache, and configured to receive address information and data of the first level cache.

In another general aspect, a cache control method includes: receiving a data request instruction; calling data for the first level cache according to the data request instruction; when the first level cache fails to call the data, reading information of a line continued with a line including the data request instruction; temporarily storing data, transferred from the first level cache or the second level cache to a core, in a prefetch buffer in a cache read operation; and receiving address information and data of the first level cache in the cache read operation.

Other features and aspects will be apparent from the following detailed description, the drawings, and the claims.

### BRIEF DESCRIPTION OF THE DRAWINGS

FIG. 1 is a block diagram illustrating a cache control apparatus according to the present invention.

FIG. 2 is a block diagram illustrating an operation of a prefetch buffer according to the present invention.

FIG. 3 is a block diagram illustrating an operation of a write buffer according to the present invention.

FIG. 4 is a flowchart illustrating a cache control method according to the present invention.

FIG. 5 is an exemplary diagram of a computer system implementing an embodiment of the present invention.

### DETAILED DESCRIPTION OF EMBODIMENTS

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

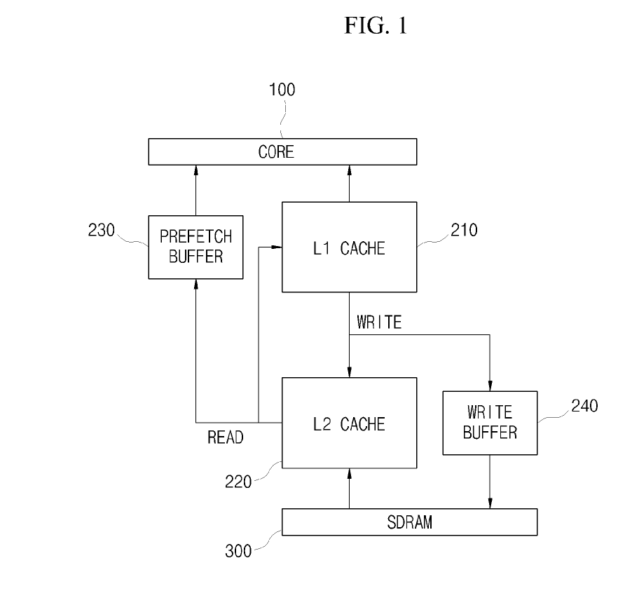

FIG. 1 is a block diagram illustrating a cache control apparatus according to the present invention.

Referring to FIG. 1, the cache control apparatus according to the present invention includes a first level cache (L1 cache) 210 that stores data of a memory, a second level cache (L2 cache) 220 that is connected to the first level cache 210, a prefetch buffer 230 that is connected to the first and second level caches 210 and 230 and temporarily stores data transferred from the first and second level caches 210 and 230 to a core 100, and a write buffer 240 that receives address information and data of the first level cache 210.

When the first level cache 210 fails to call data according to a data request instruction, the second level cache 220 is accessed by a processor.

The second level cache is a write-through cache, and forms an inclusive cache structure with the first level cache 210.

The write-through cache is a cache having a structure for supporting a method in which when a central processing unit (CPU) intends to write data in a main memory unit or a disk, the data is first written in the cache, and simultaneously, the data is written in the main memory unit or the disk.

The prefetch buffer 230 receives data of a data read operation of at least one of the first and second level caches 210 and 220, and stores the received data. When the first level cache 210 fails to call data, the prefetch buffer 230 reads information of a line including the data request instruction and information of a line continued therewith before accessing the second level cache 220, and stores information of the continued line.

The first level cache 210 calls requested data from the continued line according to the data request instruction.

That is, due to a miss of the first level cache 210, the prefetch buffer 230 reads, in addition to a line including a missed instruction code requested by the first level cache 210, information of one more line continued therewith before accessing the second level cache 220, and stores information of the continued line in the prefetch buffer 230.

Through such an operation, a penalty for a miss is given to the first level cache 210, but the prefetch buffer 230 reads instruction codes of a maximum of two lines. Therefore, the prefetch buffer 230 induces a hit from the first level cache 210 without accessing the second level cache 220.

The write buffer 240 includes a plurality of buffers. The write buffer 240 receives data in the data read operation of the first level cache 210, and stores the received data. When the data in the data read operation includes continuous address information, the write buffer 240 reads the data in the data read operation in the plurality of buffers in consideration of the address information.

At this time, the second level cache 220 receives dirty information of the first level cache 210 which is generated due to a data mismatch between a memory and the first level cache 210, and performs a read operation on the received dirty information. In this case, the second level cache 220 performs, by predetermined double words, a write operation for the dirty information of the first level cache 210.

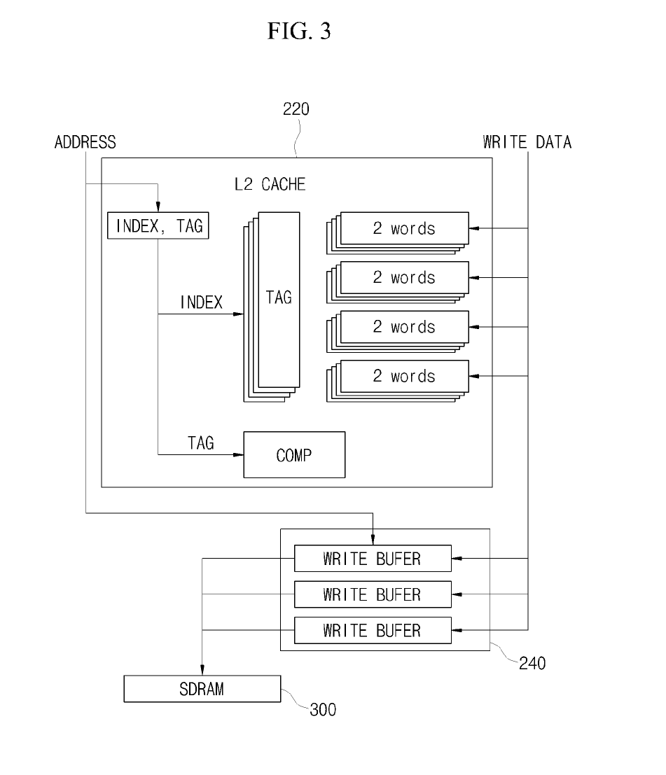

FIG. 3 is a block diagram illustrating an operation of the write buffer 240 according to the present invention. According to an embodiment of the present invention, in order to increase an efficiency of the write buffer 240, a dirty-bit configuration of the first level cache 210 is composed in units of 64 bits, and is composed of 4 bits per line.

When writing the dirty information of the first level cache 210 in the second level cache 220, the dirty information of all lines of the first level cache 210 is not written in the second level cache 220, and the dirty information is written in units of a predetermined word (for example, 2 words).

Therefore, a sufficient performance of a cache can be acquired even without increasing a depth of the write buffer 240.

In order to minimize an occupation of a synchronous dynamic random access memory (SDRAM) 300, the write buffer 240 may simultaneously write a maximum of 32 words in the SDRAM 300. To this end, for example, by using three physically different buffers, the write buffer 240 may check whether an address is a continued address, and store the words in a continued buffer in a next entry.

When a flush or a dirty line is replaced in the first level cache 210, information of the first level cache 210 is written in the second level cache 220 that forms the inclusive cache structure with the first level cache 210. Also, since the second level cache 220 is the write-through cache that uses a write-through policy, the information of the first level cache 210 may be simultaneously written in the SDRAM 300 in addition to the second level cache 220.

In this case, however, a lot of penalties occur. In a case of using the write buffer 240, the information has been completely stored in the write buffer 240, and then, the first level cache 210 may perform a subsequent operation.

The first level cache 210 of the cache control apparatus according to the present invention is a write-back cache, and the second level cache 220 is the write-through cache.

That is, the second level cache 220 uses the write-through policy, and the first level cache 210 is configured with a data cache with an instruction cache. Therefore, reflecting a dirty line in the SDRAM 300 through a flush operation is inefficient. This is because the instruction cache is written from the processor, and thus, half of a cache is not dirty in average.

Therefore, the first level cache 210 of the cache control apparatus according to the present invention transmits information about the flush operation to the second level cache 220 in performing the flush operation. In the case of a flush, when the second level cache 220 writes information in the SDRAM 300 through the write-through operation, a penalty that occur in the write-through operation is reduced by using the write buffer 240.

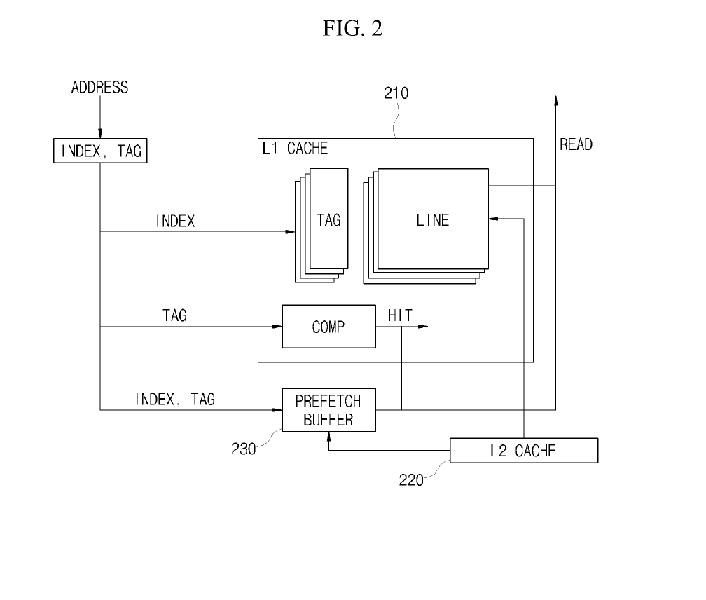

FIG. 2 is a block diagram illustrating an operation of the prefetch buffer 230 according to the present invention.

Referring to FIG. 2, in an operation of the first level cache 210 of the cache control apparatus according to the present invention, the first level cache 210 inspects an index and a tag (which are stored in the prefetch buffer 230), in addition to a 4-way tag of an index which is determined through an address analysis requested by the processor for hit inspection, and when the prefetch buffer 230 is hitten, the first level cache 210 reads information from the prefetch buffer 230.

The prefetch buffer 230 stores information of a first line when a miss occurs, and then a storage operation is performed during a next cycle. However, a bandwidth between the first and second level caches 210 and 220 has a bandwidth equal to one line, and thus, in terms of a structure of the prefetch buffer 230, when the prefetch buffer 230 receives a next address during a next cycle, the prefetch buffer 230 is in a state where the prefetch buffer 230 is updated with a new line. That is, a delay time when reading two lines for updating the prefetch buffer 230 does not decrease an access performance of the first level cache 210.

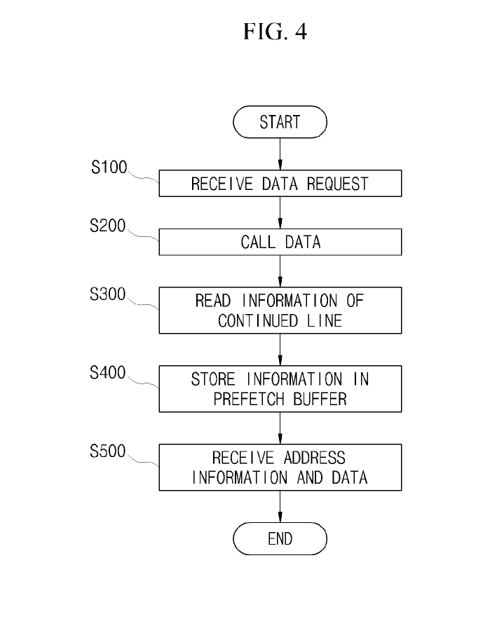

FIG. 4 is a flowchart illustrating a cache control method according to the present invention.

Referring to FIG. 4, the cache control method according to the present invention includes operation S100 that receives a data request instruction, operation S200 that calls data for a first level cache according to the data request instruction, operation S300 that reads information of a line continued with a line including the data request instruction when the first level cache fails to call the data, operation S400 that temporarily stores data, transferred from the first level cache or a second level cache to a core, in a prefetch buffer, and operation S500 that receives address information and data of the first level cache in a cache write operation.

Moreover, the cache control method according to the present invention may further include an operation that writes dirty information of the first level cache in the second level cache that forms an inclusive structure with the first level cache.

The operation, which writes the dirty information of the first level cache in the second level cache, receives dirty information of the first level cache which is generated due to a data mismatch between a memory and the first level cache, and writes, by predetermined double words, the dirty information of the first level cache in the second level cache.

When the first level cache is a write-back cache and is configured with an instruction cache and a data cache, and the second level cache is a write-through cache, reflecting all dirty lines of the first level cache is inefficient. Therefore, even though a line of the first level cache includes the dirty information, information of all lines is not written in the second level cache, and a write operation is performed by predetermined double words.

In this case, the cache control method according to the present invention may further include an operation that transmits information about a flush operation of the first level cache to the second level cache and a write buffer in the flush operation, in consideration the dirty information of the first level cache.

In the cache control method according to the present invention, operation S300 of reading the continued line reads information of the line continued with the line including the data request instruction when the first level cache fails to call the data, and thus increases a hit rate of the first level cache without accessing the second level cache.

In the cache control method according to the present invention, operation S500 of receiving the address information and data of the first level cache receives data of a cache write operation in a plurality of buffers in consideration of the address information when the data of the cache write operation includes a continued address.

For example, in order to minimize the occupation of the SDRAM, the write buffer may simultaneously write a maximum of 32 words in the SDRAM. To this end, physically different buffers are used, and the 32 words are stored in the buffers in consideration of continued address information.

As described above, the cache control apparatus and method according to the present invention prevents a miss when a continuous line request is performed through an address, thereby increasing a hit rate of a first level cache having a relatively small capacity.

Moreover, according to the present invention, an undesired flush operation is prevented, and a miss penalty is reduced.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

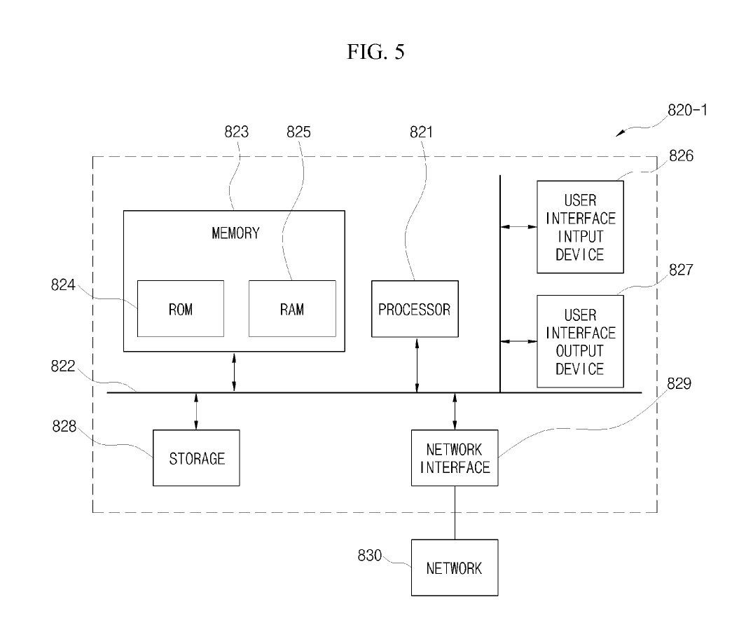

An embodiment of the present invention may be implemented in a computer system, e.g., as a computer readable medium. As shown in in FIG. 5, a computer system 820-1 may include one or more of a processor 821, a memory 823, a user input device 826, a user output device 827, and a storage 828, each of which communicates through a bus 822. The computer system 820-1 may also include a network interface 829 that is coupled to a network. The processor 821 may be a central processing unit (CPU) or a semiconductor device that executes processing instructions stored in the memory 823 and/or the storage 828. The memory 823 and the storage 828 may include various forms of volatile or non-volatile storage media. For example, the memory may include a read-only memory (ROM) 824 and a random access memory (RAM) 825.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

What is claimed is:

1. A cache control apparatus comprising:
a first level cache configured to store data in a memory;
a second level cache connected to the first level cache, and configured to be accessed by a processor when the first level cache fails to call data according to a data request instruction;
a prefetch buffer connected to the first and second level caches, and configured to temporarily store data transferred from the first and second level caches to a core; and
a write buffer connected to the first level cache, and configured to receive address information and data of the first level cache.

2. The cache control apparatus of claim 1, wherein the second level cache is a write-though cache, and forms an inclusive cache structure with the first level cache.

3. The cache control apparatus of claim 1, wherein the prefetch buffer receives and stores data of a data read operation of at least one of the first and second level caches.

4. The cache control apparatus of claim 3, wherein when the first level cache fails to call the data, the prefetch buffer reads information of a line including the data request instruction and a line continued therewith before accessing the second level cache, and stores information of the continued line.

5. The cache control apparatus of claim 4, wherein the first level cache calls requested data from the continued line according to the data request instruction.

6. The cache control apparatus of claim 1, wherein the write buffer receives and stores data of a data write operation of the first level cache.

7. The cache control apparatus of claim 6, wherein,
the write buffer comprises a plurality of buffers, and
when the data of the data write operation includes continuous address information, the write buffer stores the data of the data write operation in the plurality of buffers in consideration of the address information.

8. The cache control apparatus of claim 2, wherein the second level cache receives dirty information of the first level cache which is generated due to a data mismatch between a memory and the first level cache, performs a read operation on the received dirty information, and performs, by predetermined double words, the write operation on the dirty information.

9. The cache control apparatus of claim 2, wherein, in a flush operation of the first level cache, the first level cache transmits information about the flush operation of the first level cache to the second level cache.

10. The cache control apparatus of claim 9, wherein the write buffer receives and stores the information about the flush operation of the first level cache, and transmits the stored information about the flush operation to the memory.

11. A cache control method comprising:
receiving a data request instruction;
calling data for the first level cache according to the data request instruction;
when the first level cache fails to call the data, reading information of a line continued with a line including the data request instruction;
temporarily storing data, transferred from the first level cache or the second level cache to a core, in a prefetch buffer in a cache read operation; and
receiving address information and data of the first level cache in the cache read operation.

12. The cache control method of claim 11, further comprising writing dirty information of the first level cache in the second level cache.

13. The cache control method of claim 12, wherein the writing of dirty information comprises receiving the dirty information of the first level cache which is generated due to a data mismatch between a memory and the first level cache, and writing, by predetermined double words, the dirty information of the first level cache in the second level cache.

14. The cache control method of claim 12, further comprising, in a flush operation of the first level cache, transmitting information about the flush operation of the first level cache to the second level cache and a write buffer in consideration of the dirty information of the first level cache.

15. The cache control method of claim 11, wherein the reading of a line comprises, when the first level cache fails to call the data, reading the information of the line continued with the line including the data request instruction.

16. The cache control method of claim 11, wherein the receiving of address information and data comprises, when data of the cache write operation includes continuous address information, receiving the data of the cache write operation to store the received data in a plurality of buffers in consideration of the continuous address information.
